(19) United States
(12) Patent Application Publication
(10) Pub. No.: US 2015/0028582 A1
(43) Pub. Date: Jan. 29, 2015

(54) RV SEWER COUPLING BRACE

(71) Applicant: Carl Alton BOOZER, Jr., Leesville, SC (US)

(72) Inventor: Carl Alton BOOZER, Jr., Leesville, SC (US)

(21) Appl. No.: 14/337,579

(22) Filed: Jul. 22, 2014

Related U.S. Application Data
(60) Provisional application No. 61/857,343, filed on Jul. 23, 2013.

(51) Int. Cl. F16L 25/04

(52) U.S. Cl. CPC F16L 25/04
USPC 285/253

(57) ABSTRACT

A coupling brace is provided. The coupling brace may include a pressure element operably connected to a collar so as to hold and secure a sewage conduit and an inlet pipe tightly together. The pressure element may include a pressure plate perpendicularly joined to a pressure arm. The collar may include two annular braces perpendicularly joined to a brace arm. When the sewer conduit is disposed within the inlet pipe, the two annular braces may securely embrace the inlet pipe and be adjustably interconnected by a cinching belt about the inlet pipe. The brace arm and the pressure arm may be operably engaged to adjust the vertical dimension between the pressure plate and the two annular braces so as to prevent movement or separation between the sewage conduit and the inlet pipe through the application of inward pressure.

### CROSS-REFERENCE TO RELATED APPLICATION

This application claims the benefit of priority of U.S. provisional application No. 61/857343, filed 23 Jul. 2013, the contents of which are herein incorporated by reference.

### BACKGROUND OF THE INVENTION

The present invention relates to sewer hoses and, more particularly, to a device for easily coupling a sewer hose to a sewer pipe.

Frequenting when coupling a sewer hose to a sewer pipe, for example when locking a sewer discharge hose for a recreational vehicle to an inlet pipe of a septic tank, waste spillage occurs as well as leakage of sewer gases, resulting in an odorous, execrable mess. Current devices for preventing such spillage and leakage during the coupling are bulky, heavy and unnecessarily labor intensive to use. Moreover, some current devices cannot be used when the (inlet) sewer pipe extends significantly vertically above the surface grade, because such devices rely on the support offered the surface grade to operate properly.

As can be seen, there is a need for a coupling supporting device that is light weight, compact, easy to use and adaptable to sewer pipes extending significantly above surface grade.

### SUMMARY OF THE INVENTION

In one aspect of the present invention, a coupling brace for holding and securing a sewage conduit and an inlet pipe tightly together, comprises: a pressure plate perpendicularly joined to a pressure arm, wherein the pressure arm forms a pressure arm slot; a brace arm perpendicularly joined to two apposed annular braces, wherein the two annular braces form a cinching gap between their two terminal ends, and wherein the two annular braces define a predetermined diameter opening; a coupling hole formed within the brace arm; a cinching pin provided near the terminal end of each annular brace arm; and a cinching belt having a first end and a second end, wherein the first end forms a first pin hole, and wherein the cinching belt forms a plurality of spaced pin holes extending between the first end and the second end.

In another aspect of the present invention, a coupling brace for holding and securing a sewage conduit and an inlet pipe tightly together, comprises: a pressure plate perpendicularly joined to a pressure arm, wherein the pressure arm forms a pressure arm slot, and wherein the pressure plate forms a saddle curvature; a channel extending a portion of the pressure arm so as to circumscribe the pressure arm slot; a brace arm perpendicularly joined to two apposed annular braces, wherein the two annular braces form a cinching gap between their two terminal ends as they define a predetermined diameter opening, wherein a cinching pin is provided near the terminal end of each annular brace arm; a coupling hole formed within the brace arm; a brace lug extending a portion of the brace arm so as to incorporate the coupling hole; a cinching belt having a first end and a second end, wherein the first end forms a first pin hole, and wherein the second end provides a gripping end; and a plurality of spaced pin holes extending between the first end and the second end of the cinching belt.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a front perspective view of an exemplary embodiment of the present invention;

FIG. 3 is a rear perspective view of an exemplary embodiment of the present invention;

FIG. 4 is a front view of an exemplary embodiment of the present invention;

FIG. 5 is a side view of an exemplary embodiment of the present invention;

FIG. 6 is a section detail view of an exemplary embodiment of the present invention along line 6-6 in FIG. 1;

FIG. 7 is a section detail view of an exemplary embodiment of the present invention along line 7-7 in FIG. 1;

FIG. 8 is a rear view of an exemplary embodiment of an pressure element of the present invention;

FIG. 9 is an exploded view of an exemplary embodiment of the present invention;

FIG. 10 is a perspective view of an exemplary embodiment of the present invention;

FIG. 11 is a perspective view of an exemplary embodiment of the present invention;

FIG. 12 is a perspective view of an exemplary embodiment of the present invention; and

FIG. 13 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a coupling brace. The coupling brace may include a pressure element operably connected to a collar so as to hold and secure a sewage conduit and an inlet pipe tightly together. The pressure element may include a pressure plate perpendicularly joined to a pressure arm. The collar may include two annular braces perpendicularly joined to a brace arm. When the sewer conduit is disposed within the inlet pipe, the two annular braces may securely embrace the inlet pipe and be adjustably interconnected by a cinching belt about the inlet pipe. The brace arm and the pressure arm may be operably engaged to adjust the vertical dimension between the pressure plate and the two annular braces so as to prevent movement or separation between the sewage conduit and the inlet pipe through the application of inward pressure.

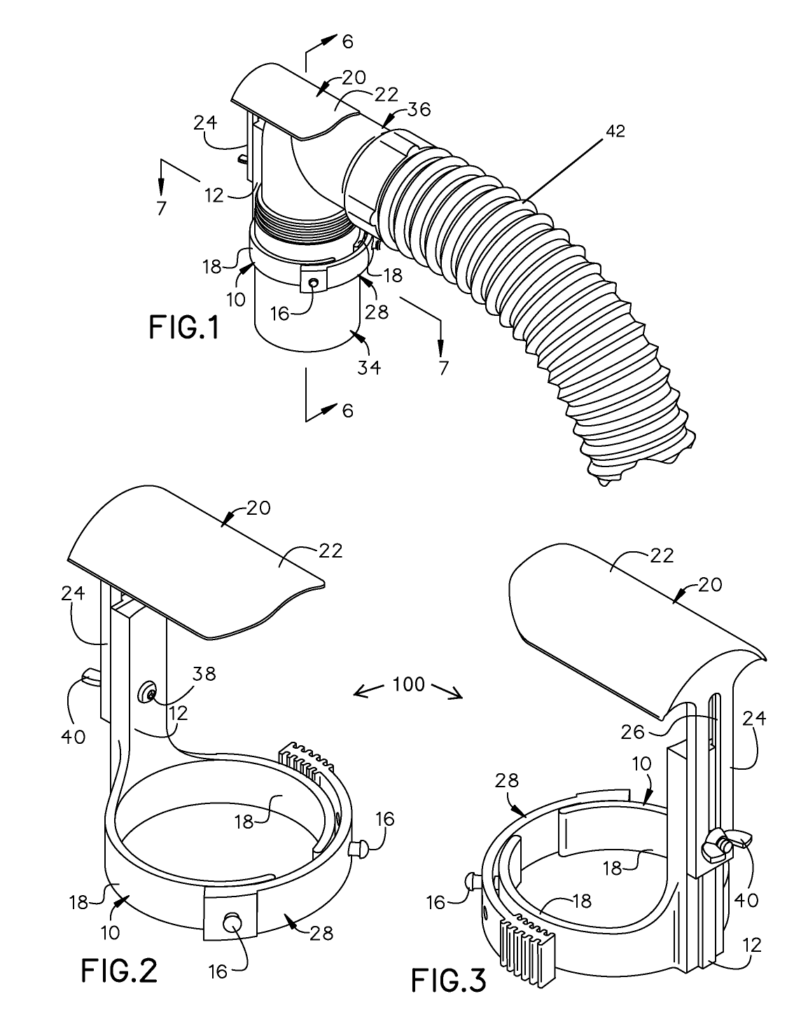

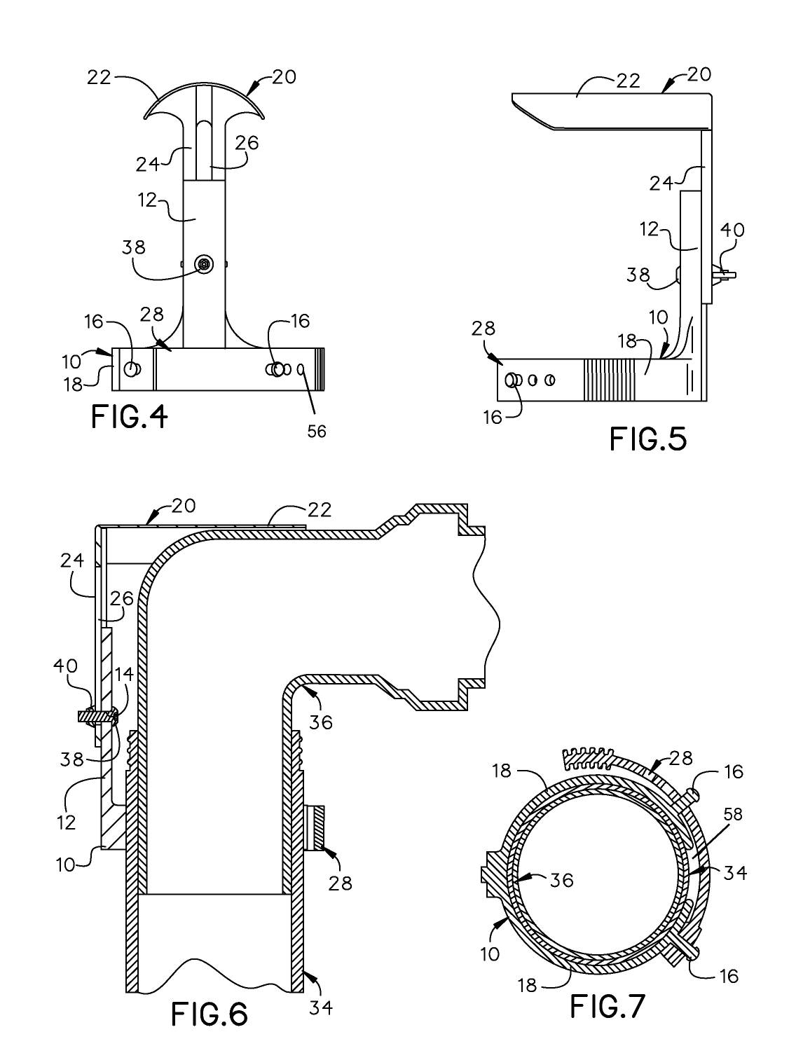

Referring to FIGS. 1 through 13, the present invention may include a coupling brace 100 for securing a sewage conduit 36 to an inlet pipe 34, wherein the sewage conduit 36 is for receiving the end of the sewer hose 42, typically from a recreational vehicle (RV).

The coupling brace 100 may include a pressure element 20 operably connected to a collar 10 so as to hold or secure the sewage conduit 36 and the inlet pipe 34 tightly together to prevent movement or separation through the application of inward pressure.

The sewage conduit 36 may have a substantially vertical portion and a substantially horizontal portion, wherein each portion may have a generally cylindrical shape. The first portion may have a first end for connection of the end of the sewer hose from the RV and a rear end which turns downwardly to, in certain embodiments, form an elbow and to join the second portion.

The pressure element 20 may include a pressure plate 22 perpendicularly joined to a pressure arm 24. The pressure plate 22 may form a saddle curvature sized and shaped so as to engage a top surface of the first portion of the sewage conduit 36.

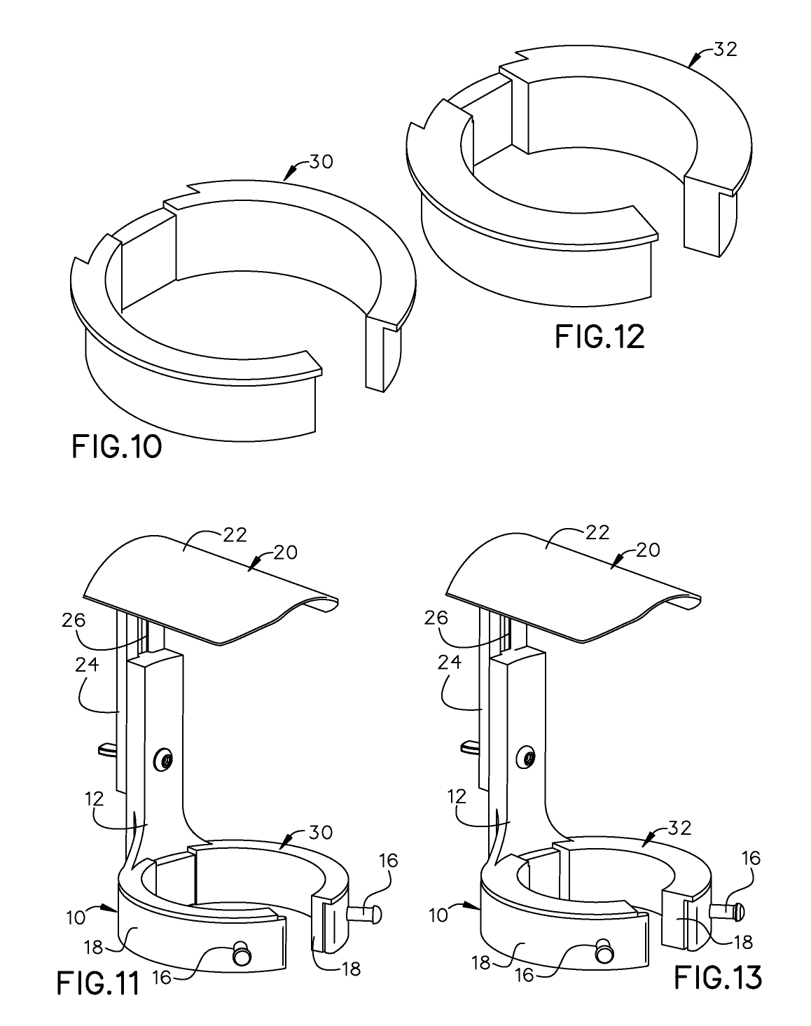

The collar 10 may include two annular braces 18 perpendicularly joined to a brace arm 12 so that the two annular braces 18 form a substantially cylindrical shape of a predetermined diameter for receiving the inlet pipe 34. The two annular braces 18 may be sized and dimensioned, as illustrated in two different embodiments in FIGS. 10 through 14, to complement various inlet pipes 36. The two annular braces 18 terminate to form a cinching gap 58 so as to provide circumferential tolerance, lateral displacement of the two annular braces 18 across the cinching gap 58 in addition to flexure when receiving and securing cylindrical elements having a diameter within a predetermined range. The predetermined range allows for adaptable use of the collar 10 when being employed on various makes and models of RV sewage conduits 36 and inlet pipes 34 now known or developed and installed in the future. A cinching pin 16 is provided near the terminal end of each annular brace 18.

The collar 10 may include a cinching belt 28 sized and shaped to simultaneously engage the two cinching pins 16 of the collar 10. The cinching belt 28 may be made of material that can be repeatedly bent and subject to tensile stresses without fracturing, such as polyethylene, polypropylene, vinyl, nylon, rubber, leather, various impregnated or laminated fibrous materials, various plasticized materials and the like. The cinching belt 28 may included a first end and a second end. The first end may form a first pin hole 52. The first end may provide a bolt pad for the first pin hole 52. The second end may form a gripping portion 54. The gripping portion 54 may be adapted to facilitate the gripping and pulling of the cinching belt 28. The cinching belt 28 forms a plurality of evenly spaced pin holes 56 along the length thereof between its first and second end.

The brace arm 12 and the pressure arm 24 may be operably engaged to adjust the vertical dimension between the pressure plate 22 and the two annular braces 18. A portion of the pressure arm 24 may define a channel 46. A pressure arm slot 26 may be formed in the brace arm 12 within the channel 46. The brace arm 12 may form a brace lug 44 extending along a portion of the length thereof. The brace arm 12 and the brace lug 44 may form a coupling hole 14 traversing through both. The coupling hole 14 may be adapted to receive a threaded fastener 38, such as a screw, bolt, rod or the like. The channel 46 may be shaped and sized to slidably receive the brace lug 44 along the length thereof so that the coupling hole 14 aligns with a portion of the pressure arm slot 26.

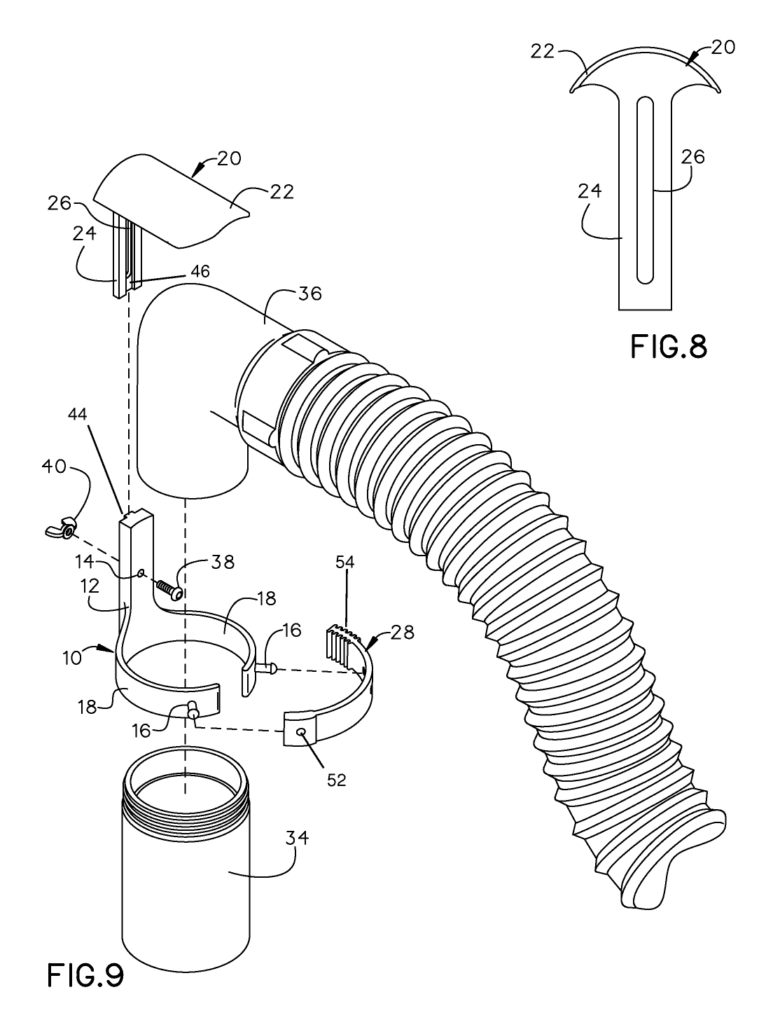

A method of using the present invention may include the following. The coupling brace 100 disclosed herein is provided. A user may slide the two annular braces 18 over the terminal end of the inlet pipe 34. In certain embodiments, the lateral displacement of the two annular braces 18 provided by the cinching gap 58 may allow the two annular braces 18 to expand to receive the terminal end of the inlet pipe 34. Then the user may dispose one cinching pin 16 within the first pin hole 52 of the cinching belt 28. Then the user may slide the second portion of the sewage conduit 36 into the terminal end of the inlet pipe 34. Then the user may apply a pulling and/or tensile force to the second end and/or the gripping portion 54 of the cinching belt 28 so as to urge the end of the annular brace 18 having the one disposed cinching pin 16 to adjustably decrease the predetermined diameter relative to the opposing annular brace 18 about the inlet pipe 34 so as to securely couple thereto. When suitably securely coupled, the user may dispose the other cinching pin 16 in an adjacent pin hole 56 of the other opposing annular brace 18, as illustrated in FIG. 7.

Then the user may slide the channel 46 of the pressure arm 24 along the brace lug 44 of the brace arm 12 until the pressure plate 22 engages the outer surface of the first portion of the sewage conduit 36, as illustrated in FIG. 1. At which time the user may rigidly couple the channel 46 and the brace lug 44 by disposing the threaded fastener 38 through the coupling hole 14 and into and through the pressure arm slot 26 so that a threaded wing nut 40 may be tightened thereto so as to adjustably bias the two arms 12, 24 together.

It should be understood, of course, that the foregoing relates to exemplary embodiments of the invention and that modifications may be made without departing from the spirit and scope of the invention as set forth in the following claims.

What is claimed is:

1. A coupling brace for holding and securing a sewage conduit and an inlet pipe tightly together, comprising:
a pressure plate perpendicularly joined to a pressure arm, wherein the pressure arm forms a pressure arm slot;
a brace arm perpendicularly joined to two apposed annular braces, wherein the two annular braces form a cinching gap between their two terminal ends, and wherein the two annular braces define a predetermined diameter opening;
a coupling hole formed within the brace arm;
a cinching pin provided near the terminal end of each annular brace arm; and
a cinching belt having a first end and a second end, wherein the first end forms a first pin hole, and wherein the cinching belt forms a plurality of spaced pin holes extending between the first end and the second end.

2. The coupling brace of claim 1, further including a channel extending a portion of the pressure arm so as to circumscribe the pressure arm slot.

3. The coupling brace of claim 2, further including a brace lug extending a portion of the brace arm so as to incorporate the coupling hole.

4. The coupling brace of claim 1, further including a gripping end near the second end of the cinching belt.

5. The coupling brace of claim 1, further including a bolt pad for the first pin hole of the cinching belt.

6. The coupling brace of claim 1, wherein the pressure plate forms a saddle curvature.

7. A coupling brace for holding and securing a sewage conduit and an inlet pipe tightly together, comprising:
a pressure plate perpendicularly joined to a pressure arm, wherein the pressure arm forms a pressure arm slot, and wherein the pressure plate forms a saddle curvature;
a channel extending a portion of the pressure arm so as to circumscribe the pressure arm slot;
a brace arm perpendicularly joined to two apposed annular braces, wherein the two annular braces form a cinching gap between their two terminal ends as they define a predetermined diameter opening, wherein a cinching pin is provided near the terminal end of each annular brace arm;
a coupling hole formed within the brace arm;
a brace lug extending a portion of the brace arm so as to incorporate the coupling hole;
a cinching belt having a first end and a second end, wherein the first end forms a first pin hole, and wherein the second end provides a gripping end; and
a plurality of spaced pin holes extending between the first end and the second end of the cinching belt.
